(19) United States
(12) Patent Application Publication
(10) Pub. No.: US 2023/0377811 A1
(43) Pub. Date: Nov. 23, 2023

(54) COMPONENT AND ELECTRICAL SYSTEM FOR AN AIRCRAFT, AND METHOD FOR CONNECTING COMPONENTS

(71) Applicants: Airbus Operations GmbH, Hamburg (DE); Airbus S.A.S., Blagnac Cedex (FR)

(72) Inventors: Peter Linde, Hamburg (DE); Alois Friedberger, Hamburg (DE); Andreas Helwig, Hamburg (DE)

(21) Appl. No.: 18/319,257

(22) Filed: May 17, 2023

(30) Foreign Application Priority Data
May 20, 2022 (EP) 22174685.2

(51) Int. Cl. H01H 1/58; H01H 1/00; H01H 3/00

(52) U.S. Cl. CPC H01H 1/5822; H01H 1/0094; H01H 2003/007; H01H 2300/036; B64D 2221/00; H01H 2207/008

(57) ABSTRACT

A component for an aircraft includes at least one connection interface, wherein the connection interface is configured to simultaneously establish an electrical connection and a mechanical connection. An electrical system for an aircraft and a method for connecting components for an aircraft are disclosed.

### TECHNICAL FIELD

The disclosure herein is directed to a component for an aircraft, an electrical system for an aircraft, and a method for connecting components.

### BACKGROUND

The current state of the art in electrical devices in aircrafts is based on separate electrical harness, analogue devices, and separate mechanical fastening of devices. For example, switches are attached on mounting plates, secured with fastener elements and connected via electrical cables.

All these parts have to be manufactured separately, collected, and installed manually. The end result is a certain amount of cost for the parts, cost for the labor of installation, and a certain amount of weight and space for the installation. In aircrafts, especially weight and space of components is always something that is desirably reduced as much as possible.

### SUMMARY

In view of the above, the disclosure herein aims to reduce the spatial and weight requirements of components to be installed in an aircraft, in particular components comprising electrical features.

According to the disclosure herein, this problem is solved by a component, an electrical system, and a method with features disclosed herein.

To that effect, a first aspect of the disclosure herein provides a component for an aircraft, the component comprising at least one connection interface, wherein the connection interface is configured to simultaneously establish an electrical connection and a mechanical connection.

A further aspect of the disclosure herein provides an electrical system for an aircraft, the electrical system comprising a first component according to the first aspect of the disclosure herein and a second component according to the first aspect of the disclosure herein, wherein the first component and second component are electrically and mechanically connected by at least one first connection interface of the first component and at least one first connection interface of the second component.

A further aspect of the disclosure herein provides a method for connecting a first component for an aircraft and a second component for an aircraft, wherein the method comprises the method step of simultaneously establishing an electrical connection and a mechanical connection between the components at a first pair of connection interfaces of the first component and the second component.

One idea of the disclosure herein lies in combining the electrical connection and the mechanical connection into one singular connection. In this way, no separate means of establishing the electrical connection and the mechanical connection respectively are needed, advantageously reducing the space and weight of the components and thereby the space and weight required by the electrical system.

Advantageous embodiments and further developments are apparent from the description with reference to the figures.

According to a further embodiment of the component, the at least one connection interface is further configured to easily release the electrical connection and the mechanical connection. This allows for advantageously easy replacement of components after initial installation.

According to a further embodiment of the component, the at least one connection interface comprises nano wires. Nano wires provide advantageous properties for establishing electrical and mechanical connections, as explained in further detail in a later part of the present description.

According to a further embodiment of the component, the component comprises a flexible material. This can provide an advantage during installation of the component, depending on its dimensions.

According to a further embodiment of the electrical system, the at least one first connection interface of the first component and the at least one first connection interface of the second component are connected by a connector, in particular by a foil comprising nano wires or by a conductive adhesive. This allows for an advantageously simplified fabrication of the components.

According to a further embodiment of the electrical system, the first component and the second component each comprise a plurality of connection interfaces and are mechanically connected by at least one second connection interface of the first component and at least one second connection interface of the second component. In this way, the mechanical stability of the connection can be further improved.

According to a further embodiment of the electrical system, the first component and the second component are further connected by an adhesive. In this way, the mechanical stability of the connection can be further improved.

According to a further embodiment of the method, the step of simultaneously establishing the electrical connection and mechanical connection comprises an application of at least one of pressure, heat, and electrical current to the first pair of connection interfaces. This allows for an advantageously easy establishing of the connection and can even be utilized to test the electrical connection right away.

The above embodiments and further developments can be combined with each other as desired, if useful. Further possible embodiments, further developments and implementations of the disclosure herein also comprise combinations of features of the disclosure herein described above or below with respect to the embodiments which are not explicitly mentioned. In particular, the person skilled in the art will also add individual aspects as improvements or additions to the respective basic form of the disclosure herein.

### BRIEF DESCRIPTION OF THE DRAWINGS

The disclosure herein is explained in more detail below with reference to the embodiments shown in the schematic figures.

FIG. 1 shows a schematic illustration of an electrical system according to an embodiment of the disclosure herein in a pre-assembled state; and

FIG. 2 shows a schematic illustration of an electrical system according to a further embodiment of the disclosure herein during assembly.

### DETAILED DESCRIPTION

The accompanying figures are intended to provide a further understanding of embodiments of the disclosure herein. They illustrate embodiments and, in connection with the description, serve to explain principles and concepts of the disclosure herein. Other embodiments and many of the advantages mentioned will be apparent with reference to the drawings. The elements of the drawings are not necessarily shown to scale with respect to each other.

In the figures of the drawings, identical elements, features and components that have the same function and the same effect are each given the same reference signs, unless otherwise specified.

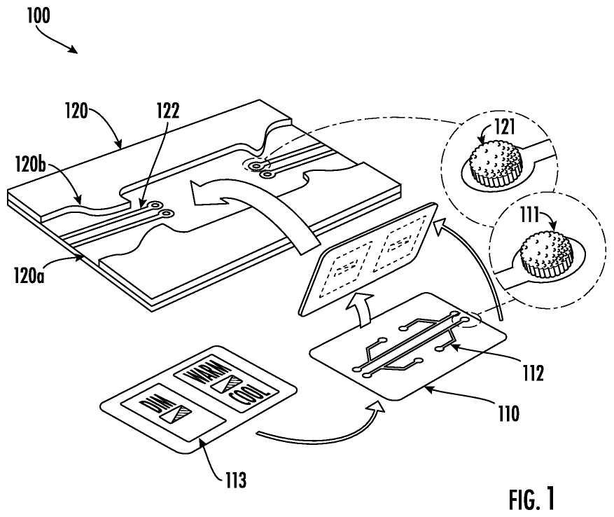

FIG. 1 shows an electrical system 100 according to an embodiment of the disclosure herein in a pre-assembled state, wherein a first component 110 of the electrical system 100 is shown at different points in time.

The electrical system 100 comprises a first component 110 and a second component 120. In the embodiment shown, the first component 110 takes the form of a circuit board, and the second component takes the form of a cabin panel built of a composite material. The first component 110 comprises a plurality of connection interfaces 111, one of which is shown in an exploded view, an electronic circuit 112, and functional areas 113 on a side opposite to the side, on which the connection interfaces 111 and the electronic circuit 112 are arranged. The second component 120 comprises a plurality of connection interfaces 121, one of which is shown in an exploded view, and an electronic circuit 122. The second component 120 further comprises a first ply 120a on which the connection interfaces 121 and the electronic circuit 122 are arranged, and a second ply 120b, which forms a cover ply to the first ply 120a. The second ply 120b comprises a cut-out area granting access to the connection interfaces 121 and the electronic circuit 122.

In the embodiment shown, the connection interfaces 111 of the first component 110 and the connection interfaces 121 of the second component 120 comprise nano wires arranged within a circular area, and are connected to the electronic circuits 112 and 122 respectively. The connection interfaces 111 of the first component 110 and the connection interfaces 121 of the second component 120 are arranged such that when the first component 110 is placed into the cut-out area of the second component 120, at least some of the connection interfaces 111 of the first component 110 overlap at least some of the connection interfaces 121 of the second component 120. When connection interfaces 111 and 121 of the first component 110 and second component 120 contact each other, their respective nano wires can be connected through the application of pressure, heat, or electrical current, thereby establishing both an electrical connection and a mechanical connection simultaneously.

A nano wire is a nano structure with the diameter of the order of a nano meter and that exhibits length-to-width ratios of 1000 or more. They can be manufactured top-down or bottom-up and can be made of different materials such as silver, nickel, tin selenide, etc. Nano wires can display considerable mechanical and electrical properties, in particular for establishing connection. Due to the extremely high surface area of the many nano wires, the inter diffusion process of atoms between neighboring nano wires can lead to immediate welding within a few milliseconds, even at room temperatures. Consequently, the two components form a strong mechanical joint which is at the same time a very good electrical connection and also highly thermally conductive. If electrical current is utilized to facilitate the welding process, the electrical connection can be directly tested during its establishing.

Another advantage of using nano wires is that the connection between the nano wires can be temporarily loosened by applying heat and/or electrical current. This can be facilitated if an adhesive is involved in the connection process. In this way, the connection between the components can be easily severed and, for example, the first component can be replaced.

The first component 110 shown in FIG. 1 comprises at least some connection interfaces 111 which have no complement on the second component 120. In this way, the first component 110 can be configured to be connected to other components which may have a different layout of connection interfaces than the second component shown in FIG. 1. Depending on the configuration of the connection interfaces 111, the connection interfaces 111 without direct complement could also be used to establish a mechanical connection between the first component 110 and the second component 120 without establishing an electrical connection.

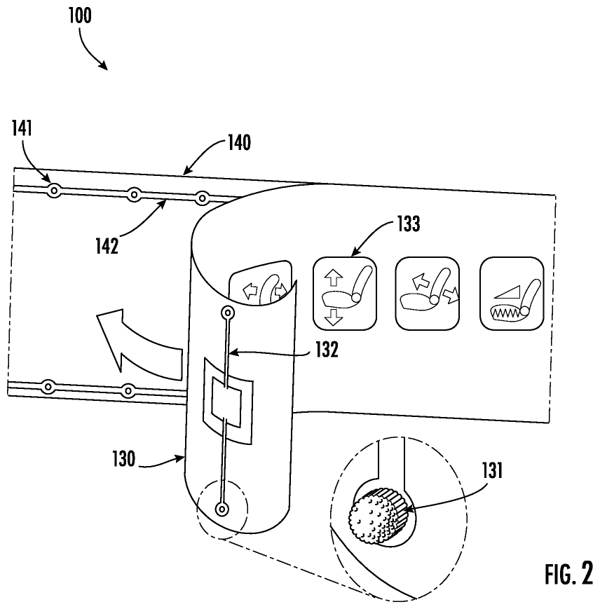

FIG. 2 shows an electrical system 100 according to a further embodiment of the disclosure herein during assembly.

The electrical system 100 comprises a first component 130 and a second component 140. In the embodiment shown, the first component 130 takes the form of a functional decor foil, and the second 140 component takes the form of a cabin panel. The first component 130 comprises a plurality of connection interfaces 131, one of which is shown in an exploded view, an electronic circuit 132, and functional areas 133 on a side opposite to the side on which the connection interfaces 131 and the electronic circuit 132 are arranged. The second component 140 comprises a plurality of connection interfaces 141 and an electronic circuit 142.

In the embodiment shown, the connection interfaces 131 of the first component 130 and the connection interfaces 141 of the second component 140 comprise nano wires arranged within a circular area, and are connected to the electronic circuits 132 and 142 respectively. The connection interfaces 131 of the first component 130 and the connection interfaces 141 of the second component 140 are arranged such that when the first component 130 is placed on top of the second component 140, at least some of the connection interfaces 131 of the first component 130 overlap at least some of the connection interfaces 141 of the second component 140. When connection interfaces 131 and 141 of the first component 130 and second component 140 contact each other, their respective nano wires can be connected through the application of pressure, heat, or electrical current, thereby establishing both an electrical connection and a mechanical connection simultaneously.

The first component 130 shown in FIG. 2 comprises a flexible material and can be bent during installation in such a way, that not all connection interfaces 131 of the first component 130 come into contact with their complementary connection interfaces 141 of the second component 140. This can lead to an easier installation of the first component 130 with respect to the second component 140, in particular if the first component 130 exceeds a certain length and/or width, compared to e.g. the components shown in FIG. 1, which are relatively compact, and which can therefore benefit from comprising rigid materials.

In FIGS. 1 and 2, nano wire bonding, wherein corresponding pairs of connection interfaces comprise nano wires. has been shown as an example of simultaneously establishing an electrical connection and a mechanical connection. This technology is advantageous as it provides beneficial properties concerning electrical and mechanical connectivity combined with a relative ease of processing. However, it is also possible for only one of a corresponding pair of connection interfaces to comprise nano wires, as even when the corresponding partner comprises, for example, only a metal coating, a sufficiently secure electrical and mechanical connection can be established, depending on the configurations of the components to be connected. Foregoing nano wires on a component itself can lead to easier manufacturing of the component. Consequently, it is also possible that neither of the components comprises nano wires itself. It could be possible to provide the connection interfaces of the components with metal coatings or plates which are then connected using a thin foil comprising nano wires, in a process similar to the process used when connecting connection interfaces comprising nano wires. It is also possible to connect connection interfaces comprising metal coatings or plates using a conductive adhesive or by providing the connection interfaces with apertures which can receive a fastener, like a screw or a bolt, which advantageously comprises a metal to reinforce the electrical connection between the connection interfaces.

In FIGS. 1 and 2, various examples of components for an aircraft have been shown. The disclosure herein is not to be limited to these examples but is intended to cover any and all components of an aircraft for which a simultaneous electrical and mechanical connection can be conceived.

While at least one example embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

100 electrical system
110 component; first component
111 connection interface
112 electronic circuit
113 functional area
120 component; second component
120a first ply
120b second ply
121 connection interface
122 electronic circuit
130 component; first component
131 connection interface
132 electronic circuit
133 functional area
140 second component
141 connection interface
142 electronic circuit

1. A component for an aircraft, the component comprising at least one connection interface, wherein the connection interface is configured to simultaneously establish an electrical connection and a mechanical connection.

2. The component according to claim 1, wherein the at least one connection interface is further configured to easily release the electrical connection and the mechanical connection.

3. The component according to claim 1, wherein the at least one connection interface comprises nano wires.

4. The component according to claim 1, wherein the component comprises a flexible material.

5. An electrical system for an aircraft, the electrical system comprising a first component and a second component, wherein each of the first component and the second component is a component according to claim 1, wherein the first component and second component are electrically and mechanically connected by at least one first connection interface of the first component and at least one first connection interface of the second component.

6. The electrical system according to claim 5, wherein the at least one first connection interface of the first component and the at least one first connection interface of the second component are connected by a connector, or by a foil comprising nano wires or by a conductive adhesive.

7. The electrical system according to claim 5, wherein the first component and the second component each comprise a plurality of connection interfaces and are mechanically connected by at least one second connection interface of the first component and at least one second connection interface of the second component.

8. The electrical system according to claim 5, wherein the first component and the second component are further connected by an adhesive.

9. A method for connecting a first component for an aircraft and a second component for an aircraft, wherein the method comprises simultaneously establishing an electrical connection and a mechanical connection between the components at a first pair of connection interfaces of the first component and the second component.

10. The method according to claim 9, wherein the first pair of connection interfaces are further configured to easily release the electrical connection and the mechanical connection.

11. The method according to claim 9, wherein at least one of the first pair of connection interfaces comprises nano wires.

12. The method according to claim 9, wherein at least one of the first component or second component comprises a flexible material.

13. The method according to claim 9, wherein the first pair of connection interfaces are connected by a connector, or by a foil comprising nano wires or by a conductive adhesive.

14. The method according to claim 9, wherein the first component and the second component are further mechanically connected by a second pair of connection interfaces of the first component and the second component.

15. The method according to claim 9, wherein simultaneously establishing the electrical connection and mechanical connection comprises an application of at least one of pressure, heat, and electrical current to the first pair of connection interfaces.
